(19) United States
(12) Patent Application Publication
(10) Pub. No.: US 2014/0073215 A1
(43) Pub. Date: Mar. 13, 2014

(54) REDUCED MASS END PLUGS FOR VOIDLESS CMH LAMPS

(71) Applicant: GENERAL ELECTRIC COMPANY, Schenectady, NY (US)

(72) Inventors: Raghu Ramaiah, Mentor, OH (US); Miles Elliot Richards, Medina, OH (US); David Allen Thompson, Avon Lake, OH (US)

(73) Assignee: GENERAL ELECTRIC COMPANY, Schenectady, NY (US)

(21) Appl. No.: 13/723,504

(22) Filed: Dec. 21, 2012

Related U.S. Application Data
(60) Provisional application No. 61/700,006, filed on Sep. 12, 2012.

(51) Int. Cl. H01J 9/26

(52) U.S. Cl. CPC H01J 9/26
USPC 445/44

(57) ABSTRACT

A voidless CMH lamp and a method of making such a lamp are provided. The CMH lamp includes a lamp body that receives at least one end plug. The end plug is constructed from a core of cermet material received within an outer layer of a ceramic material. An electrode is placed into the cermet material. The application of heat causes the cermet material to contract and eliminate voids between the lamp and cermet material. Co-sintering of the lamp, core, and outer layer provides a hermetic seal without necessarily using e.g., a sealing frit. Sintering of the ceramic material surrounding the cermet can be also used to improve light output and photometric performance of the lamp. The creation of one or more openings or recesses in the end plug can also provide performance improvements.

### PRIORITY CLAIM

This application claims the benefit of priority of U.S. Provisional Patent Application No. 61/700,006, filed Sep. 12, 2012, which is incorporated herein by reference for all purposes.

### FIELD OF THE INVENTION

The subject matter of the present disclosure relates generally to voidless ceramic metal halide lamps.

### BACKGROUND OF THE INVENTION

Ceramic metal halide (CMH) lamps (sometimes referred to as ceramic discharge metal halide lamps) generally include a tube or lamp body constructed of a ceramic material such as sintered alumina that forms a chamber into which a dose of e.g., mercury, argon, and halide salts are introduced. Electrodes are positioned at ends of the tube that, when energized, will cause the lamp to emit light. Depending upon the mixture of halide salts, the emitted light can closely resemble natural daylight. Additionally, for a comparable light output, CMH lamps can be operated with significantly less energy than a traditional, incandescent light bulb. Also, unlike lamps constructed with fused quartz, the alumina is not subject to attack from metal ions inside the tube.

A conventional construction for CMH lamps has used e.g., a tube having legs extending from the ends of the tube body. For each leg, an electrode extends within the leg and into the inside of the tube. Although placed into contact with legs, the electrodes typically have a diameter slightly smaller than the inside of the legs. This different in diameter creates a void or crevice through which one or more of the dosage materials could escape from the tube. To prevent this result, for each leg a sealing frit is typically introduced at one end of the leg into at least a portion of the voids between the electrodes and the leg.

Challenges exist with the construction, however. Even though each leg is sealed, a portion of the leg near the chamber of the lamp may still have a void into which e.g., metal halide salts can migrate. The metal halide salts dosed into the tube are corrosive, particularly at the high temperatures of lamp operation. As these salts move in and out of the leg, they can eventually cause corrosion of the leg and color instability problems. Also, the salts will attack the sealing frit particularly if the temperature of the sealing frit reaches a high temperature such as e.g., about 750° C. Once the sealing frit is penetrated by the salts, the salts and other materials dosed into the tube body will escape and the lamp will become non-functional.

Accordingly, a CMH lamp having a construction that lacks these deficiencies would be useful. Such a CMH lamp that can be constructed in a variety of different shapes would also be useful. A CMH lamp that can also be provided with features for improving e.g., light output and photometrics of the lamp would also be useful. A method of creating such a CMH lamp would also be beneficial.

### BRIEF DESCRIPTION OF THE INVENTION

The present invention provides a voidless CMH lamp and a method of making such a lamp. The CMH lamp includes an arc-tube body that receives at least one end plug. The end plug is constructed from a core of cermet material received within an outer layer of a ceramic material, such as e.g., alumina (Al₂O₃). An electrode is placed into the cermet material. The relative density of the cermet material and the outer layer of ceramic material are carefully controlled. A sintering process is used to eliminate voids between the cermet core and the outer layer of ceramic material. Sintering of the plug to the arc-tube body provides a hermetic seal by promoting grain growth across all interfaces so that the use of a sealing frit can be avoided. Sintering of the ceramic material surrounding the cermet can be also used to improve light output and photometric performance of the lamp. The creation of one or more indentations in the end plug can also provide performance improvements. Additional aspects and advantages of the invention will be set forth in part in the following description, or may be apparent from the description, or may be learned through practice of the invention.

In one exemplary aspect, the present invention provides a method of manufacturing a lamp. The lamp includes a body having an end plug received into the body. The method includes the steps of providing a mold constructed from a first mold portion connectable to a second mold portion so as to form a mold cavity, the second mold portion having a first aperture facing the mold cavity; positioning a mandrel into the first aperture of the second mold portion, the mandrel extending into the mold cavity; introducing a powder comprising a ceramic material into the mold cavity around the mandrel; compressing the powder around the mandrel in the mold cavity to create an end plug intermediate having an opening surrounded by ceramic material; replacing the second mold portion of the mold and the mandrel with a third mold portion defining a second aperture facing the mold cavity; inserting an electrode through the opening in the end plug intermediate and into the second aperture defined by the third mold portion; placing cermet material into the opening in the end plug intermediate; and compressing the end plug intermediate to further compact the ceramic material and cermet to create the end plug having a core of the cermet material surrounded by an outer layer of ceramic material.

In another exemplary aspect, a method of manufacturing a lamp is provided. The lamp includes a body having an end plug received into the body. The method includes the steps of preparing a powder that includes a ceramic material; compressing the powder into an end plug intermediate having an opening; creating a mixture comprising a cermet material; placing the cermet material into the opening of the end plug intermediate; and compressing the end plug intermediate to create the end plug having a core comprising cermet material surrounded by the ceramic material.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a perspective view of an exemplary embodiment of a lamp of the present invention.

FIG. 2 provides a cross-sectional view of the exemplary embodiment of FIG. 1.

FIG. 3 illustrates a perspective view of an exemplary plug of the present invention.

FIG. 4 illustrates a cross-sectional view of an exemplary embodiment of the body or bulb for the lamp of FIG. 1 with an exemplary dosing tube shown.

FIG. 5 provides a perspective view of another exemplary embodiment of a lamp of the present invention.

FIG. 6 is a perspective view of another exemplary embodiment of an end plug of the present invention.

FIG. 7 provides a perspective view of another exemplary embodiment of a lamp of the present invention.

FIGS. 8-12 are perspective views of additional exemplary embodiments of an end plug of the present invention.

FIG. 13 is a cross-sectional view of an exemplary embodiment of a plug of the present invention.

FIGS. 14 and 15 are cross-sectional views of an exemplary mold used to illustrate an exemplary method of the present invention.

FIG. 16 are perspective views illustrating another exemplary method of the present invention.

FIGS. 17 and 18 provide perspective views showing the appearance of an exemplary cermet in the sintered state with an hourglass shape.

FIGS. 19, 20, and 21 are perspective views showing exemplary indentations in exemplary plugs of the present invention.

FIGS. 22 and 23 are perspective views showing an exemplary “blind hole” embodiment.

FIGS. 24 and 25 are perspective views of the stop of an exemplary plug.

FIGS. 26-37 are cross-sectional views illustrating exemplary end plugs of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

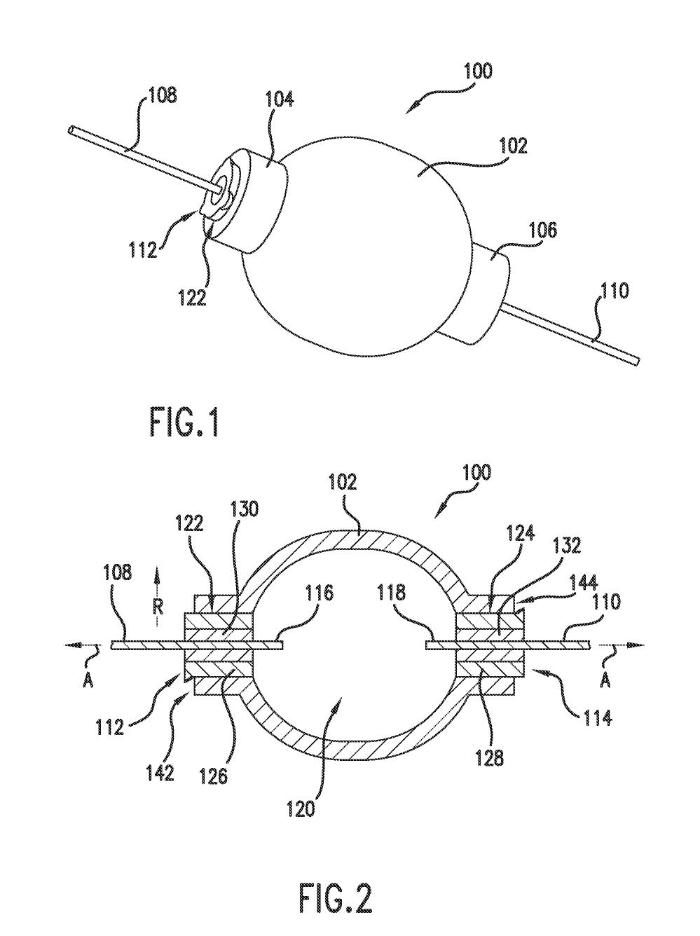

FIG. 1 illustrates a perspective view of an exemplary embodiment of a lamp 100 of the present invention while FIG. 2 provides a cross sectional view of lamp 100. Lamp 100 includes a body 102 defining a chamber 120 into which various materials have been added such as e.g., mercury, a metal halide salt, and an inert gas. Body 102 also defines a pair of openings 122 and 124 spaced apart from each other along the axial direction A and positioned on opposing sides of chamber 120 as best seen in the cross-sectional view of body 102 provided in FIG. 4. Body 102 may be constructed from a ceramic material e.g., aluminum oxide that, upon sintering, will become translucent or transparent such that light may be emitted from chamber 120.

A pair of plugs 112 and 114 are inserted into openings 122 and 124, respectively, of body 102. For this exemplary embodiment of lamp 100, openings 122 and 124 are provided by legs 104 and 106 that are connected to body 102 and extend away from chamber 120. Plug 112 includes a core 130 positioned within an annular outer layer 126. More particularly, for this exemplary embodiment, annular outer layer 126 is positioned radially outward (radial direction denoted by arrow R) of core 130. By way of example, annular outer layer 126 may be constructed from e.g., aluminum oxide or other ceramic materials. Although shown as circular or annular, outer layer 126 may be constructed from other shapes as well.

Core 130 may be constructed from e.g., a cermet—i.e. mixture of a ceramic material and an electrically-conductive metal. For example, core 130 may be constructed from a mixture of aluminum oxide and molybdenum; other compositions may also be used. Plug 114, including core 132 and annular outer layer 128 is constructed in a similar manner.

A pair of electrodes 108 and 110 are positioned in cores 130 and 132. Electrodes 108 and 110 each include a tip 116 and 118, respectively, that extends into chamber 120. A variety of materials and constructions may be used for the electrodes. For example, each electrode 108 and 110 may be a single wire lead as shown or may be wrapped within coils formed by another wire lead. Electrodes 108 and 110 may be constructed from materials such as e.g., tungsten, tungsten with molybdenum section welded together, molybdenum, or tungsten with a cermet section.

Each electrode 108 and 110 has an electrode diameter along radial direction R. Each core 130 and 132 also has a core diameter along radial direction R. In one exemplary embodiment of the invention, the core diameter is less than about 10 times the electrode diameter. Other ratios may also be used.

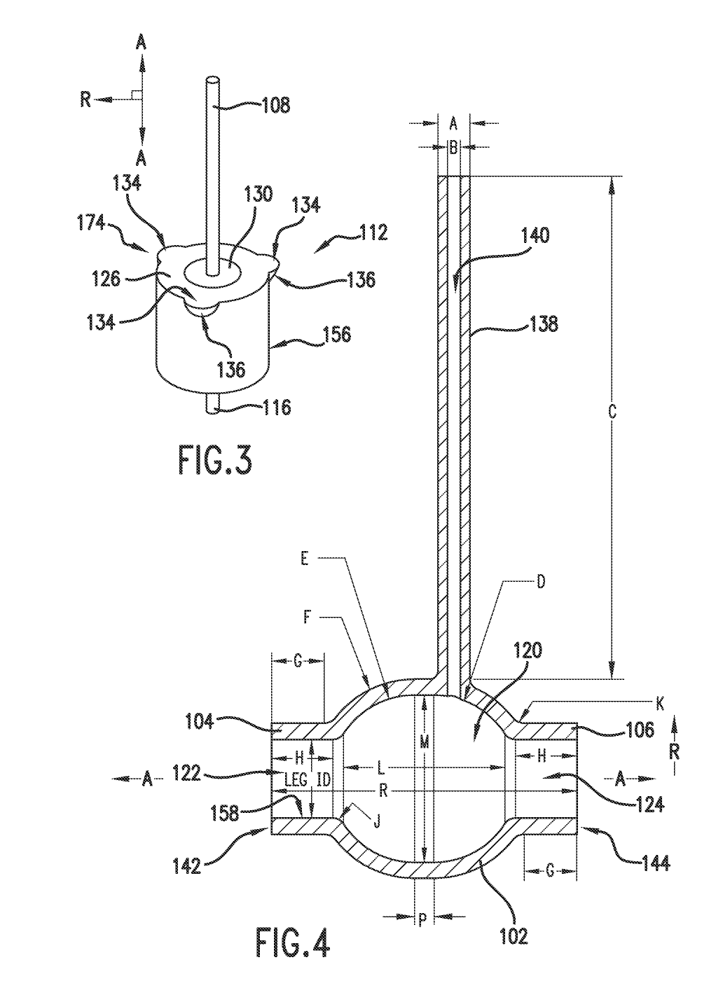

During construction, plugs 112 and 114 are inserted into openings 122 and 124 as previously stated. Plugs 112 and 114 can each be provided with features for accurately controlling the amount by which plugs 112 and 114 extend into legs 104 and 106, respectively, to close openings 122 and 124. Referring to FIGS. 3, 24, and 25 and using plug 112 for example, plug 112 includes a plurality of stops 134 positioned at a distal end 174. Stops 134 extend radially outward from the plug and past outer wall 156. Stops 134 are also discontinuous along circumferential direction C (FIG. 24)—meaning they do not extend completely around the circumference of plug 112. Each stop 134 also includes an angled surface 136—i.e. a surface that is non-parallel to the axial direction A. As plug 112 is inserted into opening 122, stops 134 eventually contact outer edge 142, which prevents further movement of plug 112 along axial direction A. Plug 114 is provided with similar stop 134 for contacting outer edge 144.

FIGS. 24 and 25 identify additional unique features or parameters of the stops 134 used with plugs 112 and 114. These parameters can be used to further define exemplary plugs of the present invention as well. Determined experimentally, these parameters provide for proper functioning of the lamp when used to manufacture the plug and stops described herein:

IL=Ah−Sh Eqn. 1

IL≧1.2 mm Eqn. 2

0≧SI<1/2*(Ad) Eqn. 3

0≦Sw≦Ad Eqn. 4

0≦Sa<180 Eqn. 5

Referencing FIGS. 24 and 25, IL is the insertion length of the plug into the arc-tube body 102. This insertion length IL should have a positive value, defined by Eqn. 2. Below the value of IL of about 1.2 mm, the lamp may not be hermetic after sintering. Eqn. 1 gives the relationship between this IL and the overall height of the plug (Ah) and the height of a stop (Sh). SI in FIGS. 24 and 25 and in Eqn. 3 is the protrusion of the stop. SI should follow the inequality described in Eqn. 3, where Ad is the plug diameter.

Two other parameters that can be used to define the stop used with an exemplary plug of the present invention are Sw, the Stop width, and Sa the stop Angle. These parameters are constrained by Eqn. 4 and 5. As used with an exemplary plug of the present invention, the stops define an insertion length that contributes to good hermeticity, and the above equations define the range of effectiveness of this feature. In one exemplary embodiment of the present invention, a stop such as stop 112 has the following values: SI=1.1 mm, Ad=5.2 mm, Sw=2.1 mm, Ah=3.76 mm, Sh=1.3 mm, and Sa=45 degrees. Variations of this are possible especially if they meet the inequalities described in Equations 1 through 5.

It should be noted that plugs 112 and 114 are not limited to constructions where cores 130 and 132 extend completely through along the axial direction. For example, a plug may be provided where the core extends only partially through the plug and lacks a cylindrical shape. As shown in FIG. 6 using plug 112, for example, core 130 may extend only partially along the axial direction A and have a conically shaped outline 157.

During construction, lamp 100 is subjected to high temperature in a controlled atmosphere. More particularly, as used herein, sintering refers to a process in which the parts are heated to a high temperature (e.g., ˜1850° C.) in the presence of a specifically selected gas such as e.g., hydrogen. The sintering will lead to e.g., grain growth between various particles used to make e.g., plugs 112 and 114. It will also cause e.g., cores 130 and 132 to contract along all radial directions R to form a hermetic seal around electrodes 108 and 110 and eliminate or prevent voids or crevices that could cause lamp failure. In addition, under such conditions, co-sintering will occur. For example, cores 130 and 132 may be co-sintered with annular outer layers 126 and 128, which may in turn be co-sintered with the legs 104 and 106 of lamp arc-tube 102. In such co-sintering, diffusion between these parts provides for grain growth that also helps form the hermetic seal that will retain the materials dosed into chamber 120 while minimizing or eliminating voids and other crevices.

Additionally, for certain exemplary embodiments, outer layers 126 and 128 of plugs 112 and 114 are constructed from aluminum oxide. During sintering, these materials will become transparent or translucent to provide lamp 100 with certain advantageous characteristics. For example, unlike a plug constructed from an opaque material, plugs 112 and 114 will allow light to pass through—increasing the light output from lamp 100. Also, by allowing more energy to escape in the form of light, a thermal benefit is provided as less heat must be dissipated from lamp 100. For this exemplary embodiment, providing a cermet diameter that is smaller than the outer layer diameter provides a unique advantage for allowing more energy to escape in the form of light.

FIG. 4 provides a cross-sectional view of the exemplary arc-tube body 102 with legs 104 and 106 used with lamp 100 shown in FIGS. 1 and 2. Because openings 122 and 124 are plugged and hermetically sealed as previously described, body 102 is provided with a dosing tube 138. A pathway 140 is defined by dosing tube 138 by which one or more materials may be introduced into chamber 120. After chamber 120 is properly dosed, dosing tube 138 can be sealed and then removed by e.g., cutting and sealing with a plasma torch. Other techniques may be used as well.

While a variety of shapes may be used for arc-tube body 102, the shape and dimensions shown in FIG. 4 are particularly effective for manufacture and light transmission for lamp 100. By way of example for this exemplary embodiment of body 102, diameter A of dosing tube 138 is about 1.6 mm, inside diameter B of dosing tube 138 is about 0.6 mm, length C of dosing tube 138 is about 25.5 mm, radius D is about 0.5 mm, radius E is about 4.2 mm, radius F is about 5 mm, length G of the outside, straight portion of leg 104 is about 2.62 mm, length H of the inside, straight portion of leg 104 is about 3.16 mm, radius J is about 0.5 mm, radius K is about 0.75 mm, dimension L is about 8.11 mm, diameter M at the entrance to tube 138 is about 8.4 mm, and length P is about 1 mm, Leg ID=4 mm. Overall length R is about 16 mm. Other dimensions may be used in other exemplary embodiments of the invention.

Table I provides exemplary dimensions, as defined by in FIG. 4, for three separate lamp wattages.

TABLE I
Range of parameters with reference to FIG. 4 (units in mm)

| | Lamp Wattage | | |
|---|---|---|---|
| Parameter | 20 w | 39 w | 70 w |
| Leg ID | 1.8 | 2.98 | 4 |
| Dia A | 1.7 | 1.72 | 2.26 |
| Dia B | 0.58 | 0.58 | 0.79 |
| Length C | 11.2 | 11.36 | 10.5 |
| Radius D | 1.23 | 1.23 | 1.5 |
| Radius E | 2 | 2.5 | 4.2 |
| Radius F | 2.6 | 3.3 | 5 |
| Length G | 1.17 | 0.98 | 2.26 |
| Length H | 1.57 | 1.6 | 3.16 |
| Radius J | 0.37 | 0.37 | 0.5 |
| Radius K | 0.56 | 0.56 | 0.75 |
| Dim L | 4 | 6.18 | 8.11 |
| Dia M | 3 | 5 | 8.4 |
| Length P | 3.6 | 2.38 | 1 |
| Length R | 7.5 | 9.95 | 15.28 |

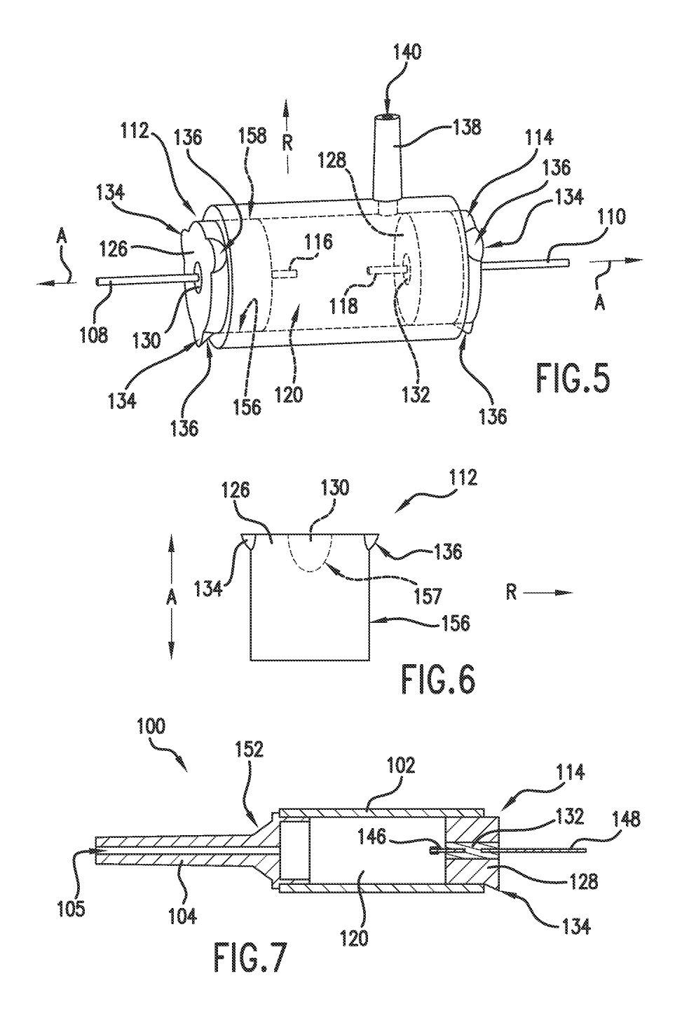

FIG. 5 illustrates another exemplary embodiment of lamp 100 having a different shape from the embodiment shown in FIGS. 1 and 2. As shown, body 102 is cylindrically-shaped along axial direction A and lacks legs. Such a cylindrical shape has the advantage of ease of manufacture. For example, outer wall 156 of plug 112 comes directly into contact with inner wall 158 of body 102. The construction of lamp 100 is otherwise similar to the embodiment shown in FIGS. 1 and 2 with like reference numerals indicating the same or similar features. Dosing port 138 is sealed and removed after chamber 120 is dosed. Other shapes and embodiments other than what is shown in FIG. 5 may be used as well.

Table II defines by way of example, relevant dimensions for a cylindrical embodiment of this invention. Radius in this table refers to the radius of the cylindrical body where the port joins the cylindrical body. Other dimensions may be used in other exemplary embodiments of the invention.

TABLE II

| Cylindrical | 20 w | 39 w | 70 w |
|---|---|---|---|
| ID | 3 | 5 | 7 |
| OD | 4.2 | 6.2 | 8.2 |
| Arc-Gap | 5.9 | 3.5 | 2.5 |
| Plug Length | 2.6 | 2.6 | 2.6 |
| Radius | 1 deg | 1 deg | 1deg |

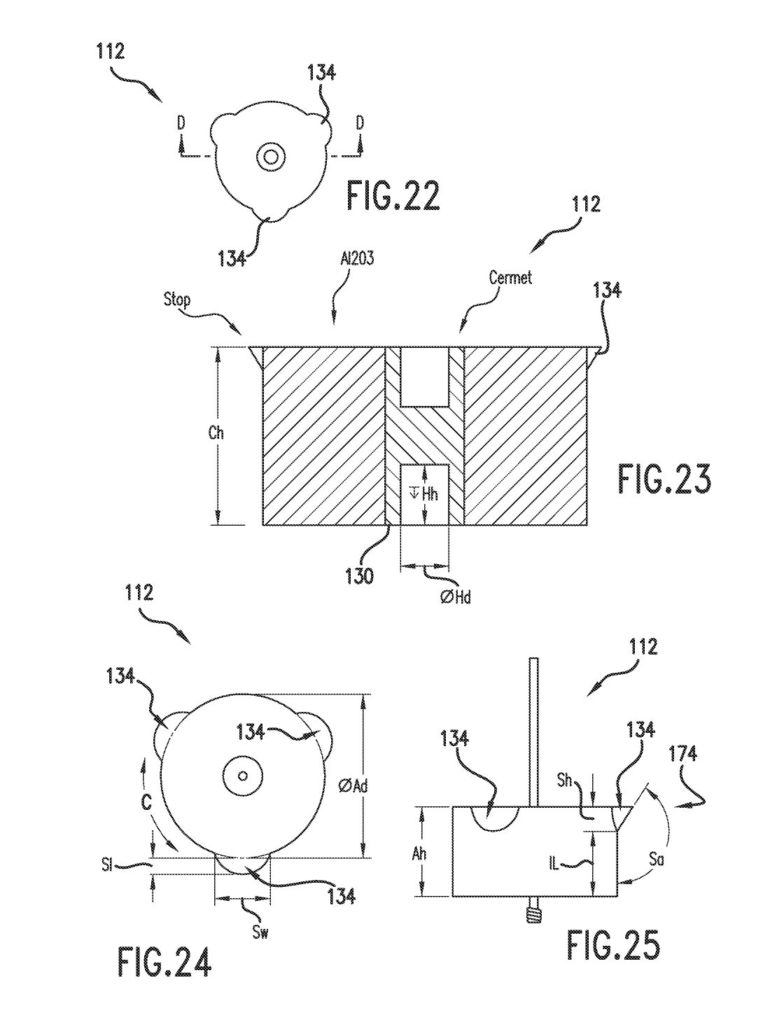

The present invention is not limited to a lamp 100 having a plug, constructed with a core and outer layer, in each end of body 102. For example, referring now to FIG. 7, another exemplary embodiment of lamp 100 is shown. A plug 114 is positioned at one end of body 102 having an annular outer layer 128 and core 132 as previously described. However, opposite to plug 114, lamp 100 includes a conventional injection molded part 152 having an extended leg 104. A hole or passage 105 is provided through injection molded part 152 for receipt of an electrode that could then be sealed in e.g., a conventional manner using a sealing frit. It should also be noted that for this exemplary embodiment, electrode 146 does not extend completely through plug 114, referred to as a blind-hole concept, as further defined in FIGS. 22 and 23. Instead, electrode 146 extends partially through one end of plug 114 while an electrically conductive lead 148 extends partially through the other end. For such an embodiment, the materials used for core 132 include e.g., an amount of electrically conductive metals that allows current to flow from lead 148 to electrode 146.

Referencing FIG. 23, experimentally, for this exemplary embodiment it has been determined that the dimensions Hh and Hd define and constrain the blind-hole concept by the following relationships set forth in Table III.

TABLE III

| | |
|---|---|
| Eqn. 6 | Hd ≧ Electrode Shank OD/1.014 |
| Eqn. 7 | Hh > 1.5 × Hd |
| Eqn. 8 | Hh < 0.5 * Ch |

Eqn. 6 defines the depth of this blind hole, which should be less than the feed through diameter in order to ensure a press fit. The height of the blind hole Hh should be greater than the diameter of blind hole, Hd, as defined by Eqn. 7. Finally, Hh should be less than the height of the cermet section Ch of the plug, as defined by Eqn. 8. By way of example, in one exemplary embodiment, Hd is about 0.644 mm, Hh is about 0.97 mm, and Ch is about 3.5 mm.

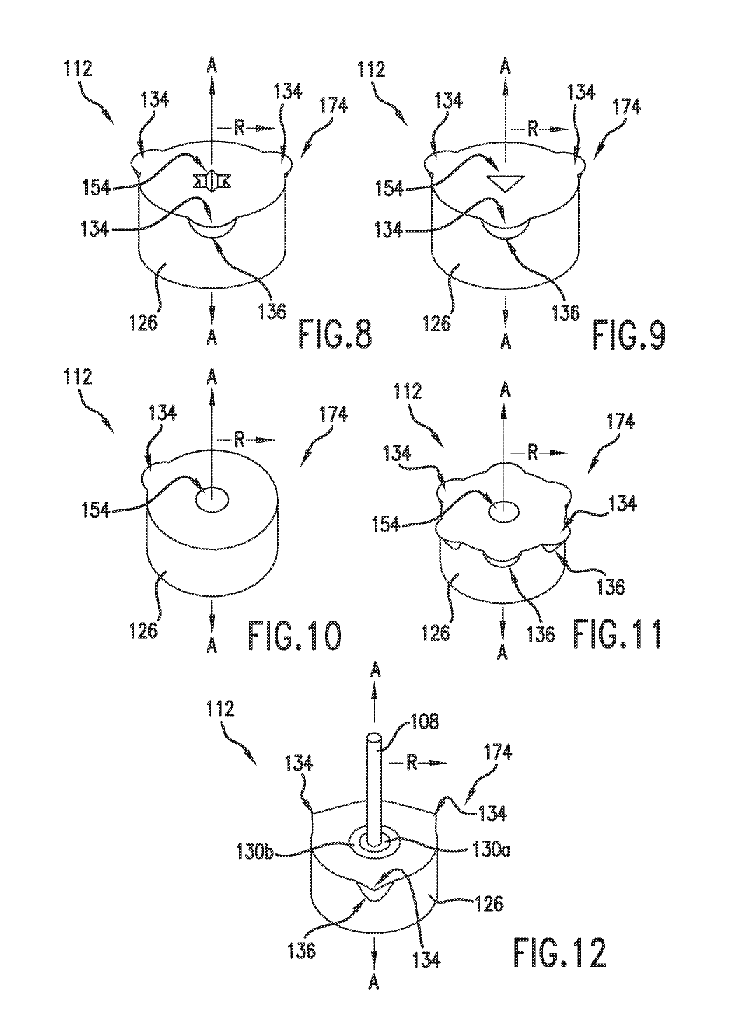

As shown in FIGS. 8 through 12, a variety of different configurations may be used for the stops and core of the plug. Referring to FIG. 8 and using plug 112, for example, three stops 134 with angled surfaces 136 are shown at distal end 174. An opening 154 is provided for receipt of the materials to create a core. In a plane perpendicular to axial direction A, opening 154 has a polygonal shape (e.g., star shape) that will provide a core of similar shape. FIG. 9 provides another exemplary embodiment of plug 122 but with a different polygonal shape for opening 154 and the resulting core it will contain. As illustrated in FIG. 10, a circular shape for opening 154 is provided. However, for this exemplary plug, only a single stop 134 is used. FIG. 11 illustrates another exemplary plug 112 having multiple stops and a circular opening 154 for receipt of a cermet core. For each of these embodiments, equations 6, 7, and 8 may constrain the dimensions of these stop features.

For the embodiments previously described, the core of each plug has been shown as a relatively homogenous material. For example, the core can be made from a material having a relatively uniform coefficient of thermal expansion throughout the core. However, the present invention also includes the use of graded cores—e.g., cores constructed from layers having different coefficients of thermal expansion. For example, FIG. 12 illustrates another exemplary plug 112 having a core 130 into which electrode 108 is positioned. Core 130 is received within outer layer 126. Core 130 includes two layers of cermet—a radially inner layer 130a and a radially outer layer 130b. Layers 130a and 130b have different coefficients of the thermal expansion. The constructions shown in FIG. 12 can be of utility in minimizing the effects of thermal expansion when core 130, outer layer 126, and the body 102 are heated during use of lamp 100. FIG. 12 is provided by way of example only. For example, a different number of layers with different shapes may also be used for core 130.

The exemplary embodiment of lamp 100 with body 102 described in FIGS. 1, 2, 4, and 5 utilize a dosing port 138 that extends radially off body 102 and provides a pathway 140 into chamber 120. By way of example, for these embodiments, dosing port 138 is constructed from the same material forming body 102. However, in other exemplary embodiments of the present invention, lamp 100 may be provided with e.g., a dosing port through one of the plugs.

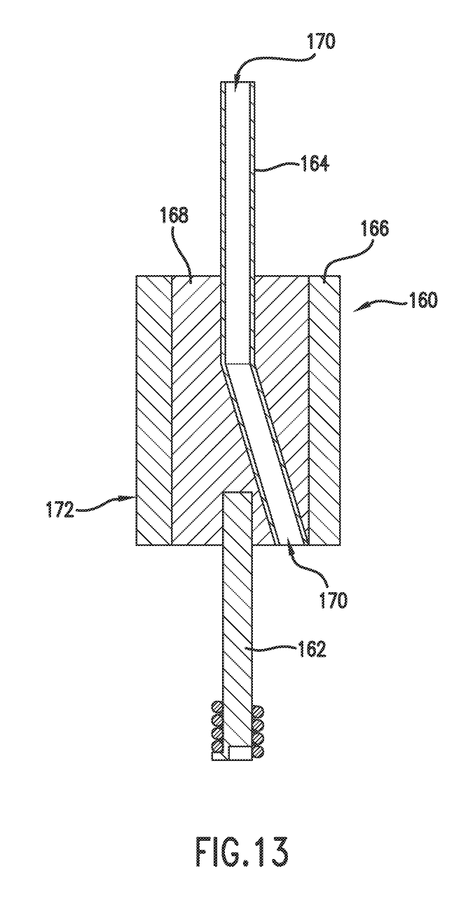

More particularly, FIG. 13 provides another exemplary embodiment for a plug 160 in which a pathway 170 for dosing chamber 120 is provided through plug 160. As shown, lead 164 is hollow so that dosing materials may be added into chamber 120 therethrough. Core 168, positioned within outer layer 166 with outer surface 172, is constructed from a cermet that will conduct current to electrode 162. In still another embodiment, lead 164 can be provided with a hollow path 170 that connects with a hole or passageway in core 168 that leads to chamber 120 of lamp 100. Other shapes and constructions for creating pathway 170 through plug 160 may be used as well.

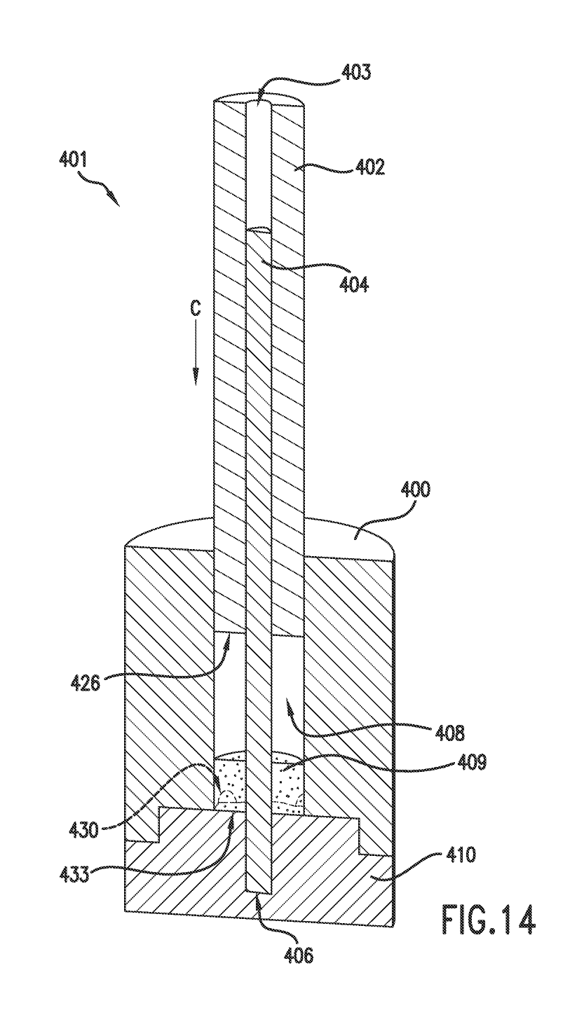

FIGS. 14 and 15 illustrate an exemplary mold 401 and method of manufacturing a lamp of the present invention and, more particularly, to exemplary steps in making an end plug for the lamp. Mold 401 is constructed from a first mold portion 400 that is releasably connected with a second mold portion 410 so as to form a mold cavity 408. Second mold portion 410 has a first aperture 406 that faces mold cavity 408. A mandrel 404 is positioned into the first aperture 406 of the second mold portion 410 and extends into the mold cavity 408 from mold surface 433.

Ceramic material in the form of e.g., a powder is placed into mold cavity 408 around mandrel 404. The powder could include e.g., aluminum oxide. The powder is compressed around the mandrel 404 in the mold cavity to create an end plug intermediate 409 (shown with dotted lines) having an opening 431 (FIG. 15) surrounded by the ceramic material. The powder is compressed by inserting a first shaft 402 into mold cavity 408 and pressing against the powder as shown by arrow C.

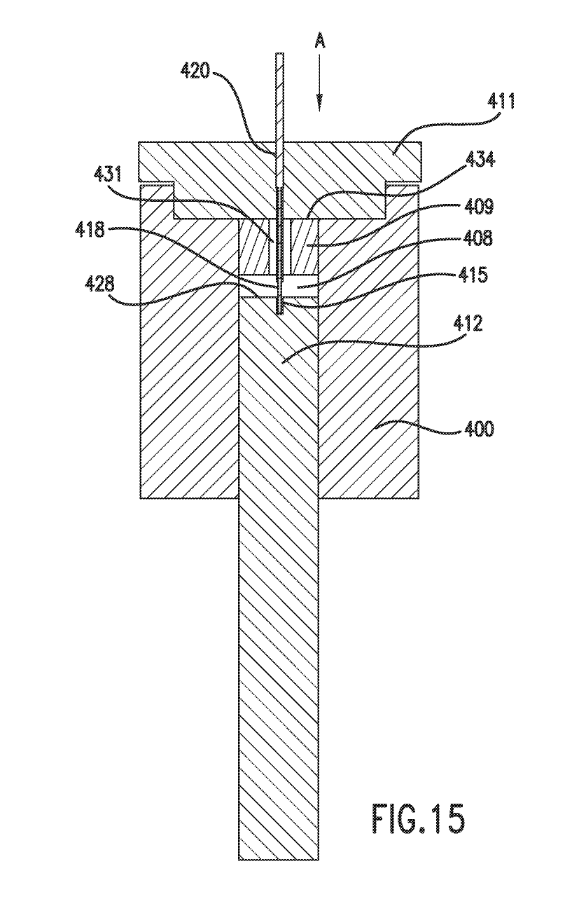

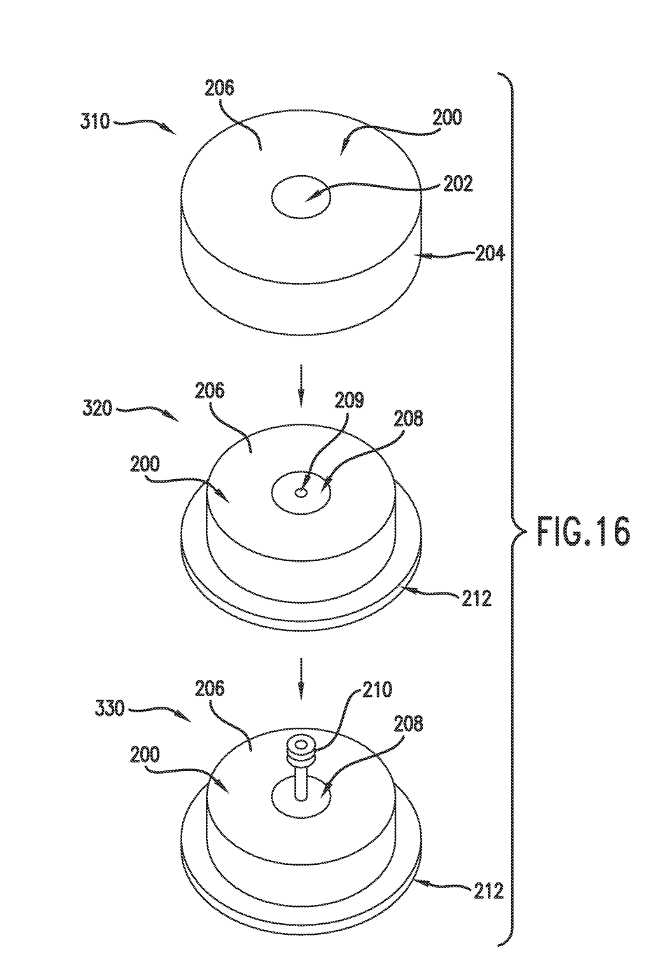

First shaft 402 includes a first guide channel 403 into which mandrel 404 is received. Mandrel 404 slides within first guide channel 403 during compression of the powder. The intermediate end plug might appear, e.g., as intermediate end plug 206 shown in FIG. 16. Alternatively, one or more recesses 430 can be provided in first mold portion 400 to create stops 134 in the end plug as shown e.g., FIGS. 8 through 11. Recesses 430 include angled surfaces that help create angled surfaces 136 on plugs 112 and 114 and also assist in ensuring that the powder is properly compressed into recesses 430 to create stops 134.

After compressing the powder to create end plug intermediate 409, second mold portion 410 and mandrel 404 are replaced with a third mold portion 411, which connects with first mold portion 400 as shown in FIG. 15. Electrode 418 is inserted into shaft 412 via a blind hole 415. Shaft 412 is then fed through barrel 400 with the first mold portion 409 already formed. When guiding shaft 412 through barrel 400, electrode 418 is fed through the opening 431 in end plug intermediate 409 that was created by mandrel 404. Once the surface 428 of shaft 412 touches the surface of plug 409, the barrel 400 and plug 409 rest on shaft 412. Cermet material is placed into opening 431. The cermet material could be e.g., a mixture of a ceramic material such as aluminum oxide and an electrically conductive metal such as e.g., molybdenum.

Another mold portion 411 is then placed on top of barrel 400. The electrode is fed through a through channel 420, which is slightly larger (e.g., one hundredth millimeter) than the electrode diameter. This operation can also be performed for a plug that does not include an electrode in the pressing process called the blind hole method. Instead of using shaft 412 with channel 415, use shaft 412 without a channel. When guiding shaft 412 without a channel through barrel 400, shaft 412 will touch the surface of plug 409. Once the plug 409 and barrel 400 are resting on shaft 412, fill opening 431 with cermet material. Place another mold portion 411 without a through hole on barrel 400.

Second shaft 412 is then moved along axial direction A in FIG. 15 to compress end plug intermediate 409 into an end plug having a core surrounded by an outer layer as previously described. The plug can then be ejected from the mold by removing mold portion 411 from barrel 400, and by applying a force to shaft 412 in the axial direction A until the plug is completely out of cavity 408. The core and outer layer of the resulting plug can be submitted to heat treatment for co-sintering as previously described. Alternatively, the plug can be inserted in a lamp body and the assembly subjected to heat treatment for co-sintering of the core, outer layer, and lamp body as previously described.

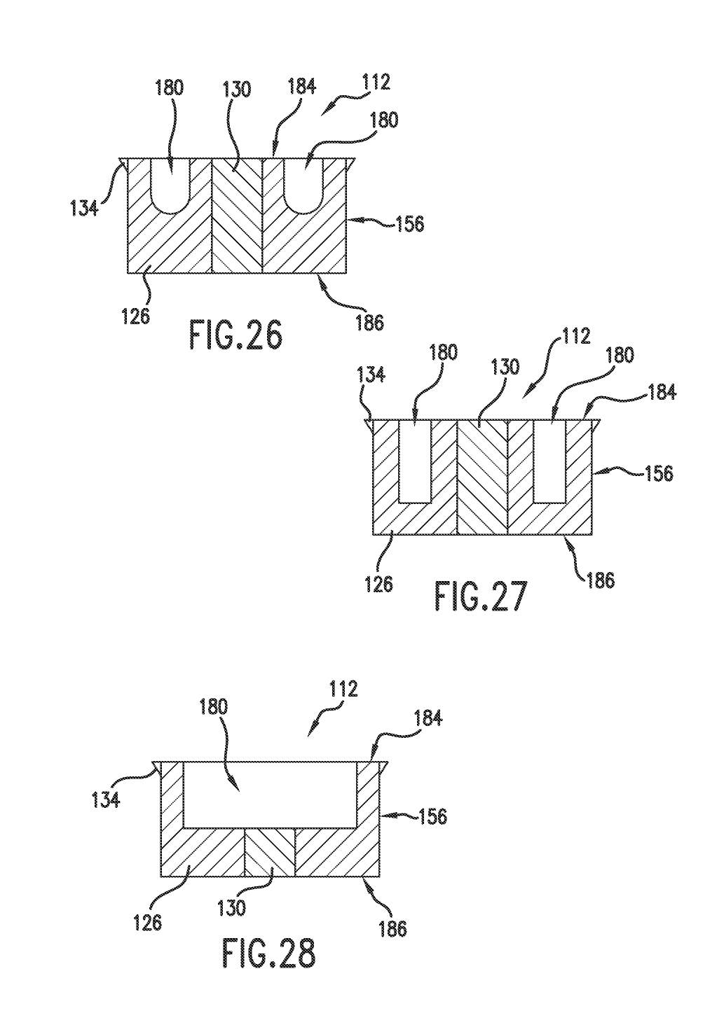

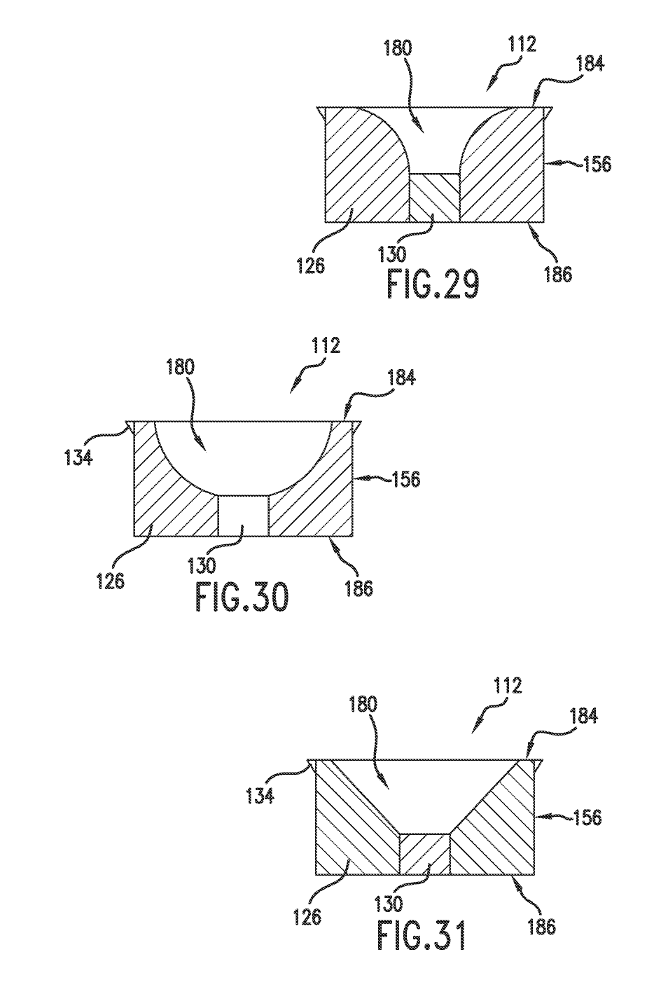

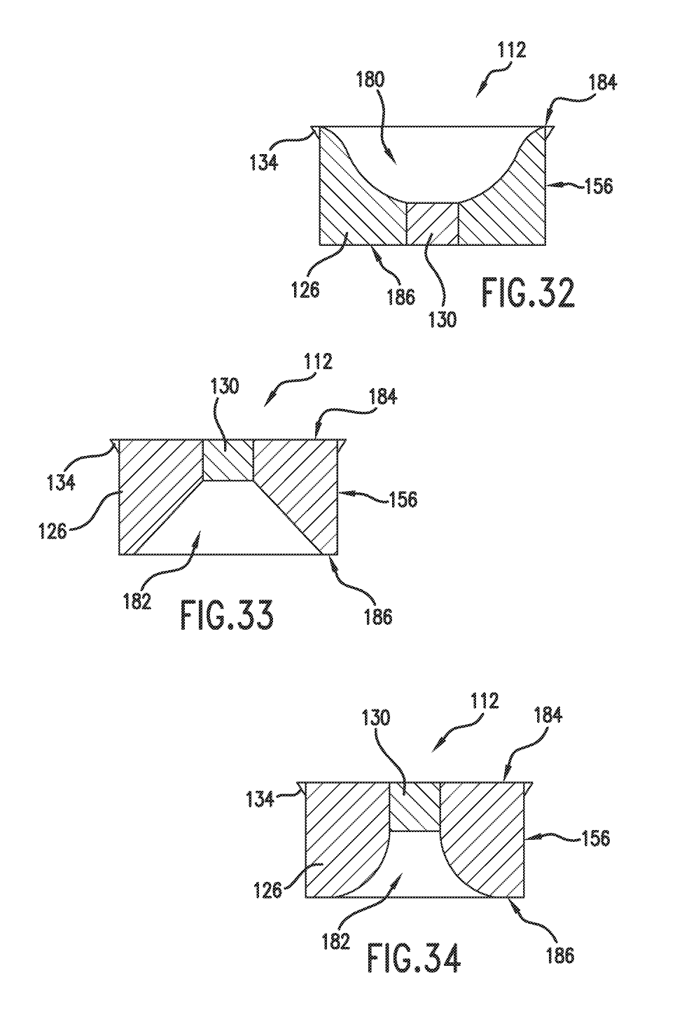

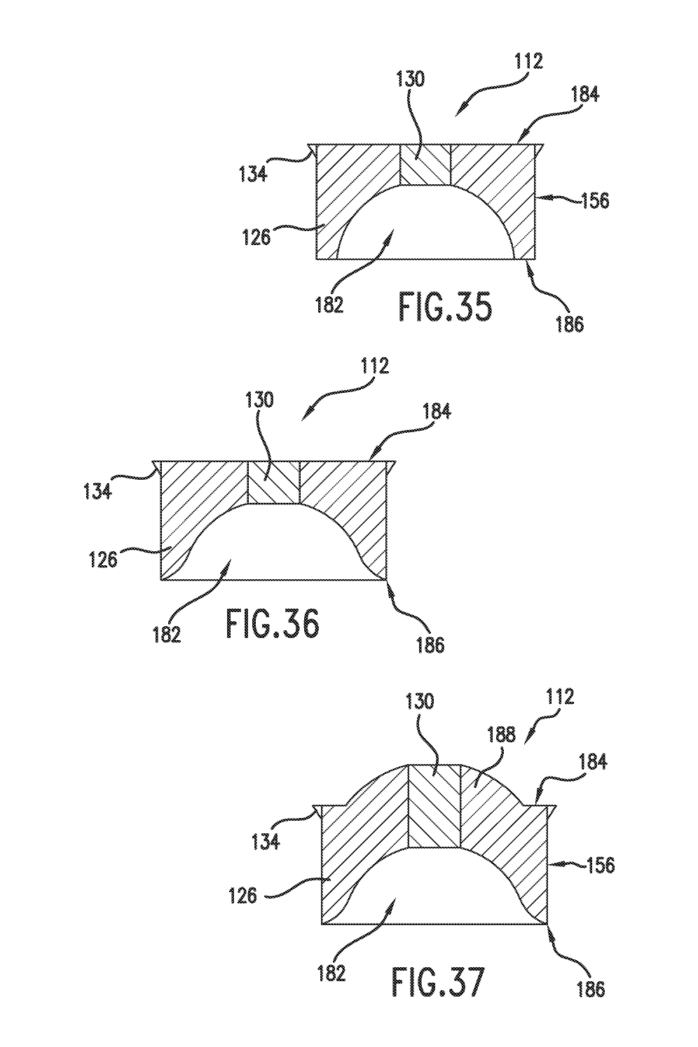

Accordingly, using end plug 112 again by way of example, FIGS. 26 through 37 illustrate cross-sectional views of additional exemplary embodiments of plug 112 that can be used to reduce the amount of material that would otherwise be heated by the lamp and thereby reduce lamp efficacy. For example, plug 112 in FIG. 26 is provided with an opening or recess 180 in outer surface 184 that extends around core 130. A different shape for opening 180 is shown in FIG. 27. As an alternative or in addition thereto, openings of similar shape could be provided on the inner surface 186 of plug 112. Other shapes for the openings can also be used to reduce the mass of the plug.

In the exemplary embodiments of FIGS. 28, 29, 30, 31, and 32, different shapes are used for openings 180 in the outer surface 184 of plug 112. Additionally, for these embodiments, the reduction in mass occurs not only in outer layer 126 (as in FIGS. 26 and 27) but also with core 130 as well. Again, this reduction in mass provides for improvement in e.g., lamp photometrics. In one exemplary embodiment of the present invention, the reduction in mass achieved by the addition of the openings described herein such that the ratio ceramic (e.g., alumina) volume (in the outer layer)/cermet volume (in the core) is greater than, or equal to, about 6. Stated mathematically, (ceramic volume/cermet volume)≧6.

In the exemplary embodiments of plug 112 shown in FIGS. 33, 34, 35, 36, and 37, different shapes are used for openings 182 in the inner surface 186 of plug 112. Also, for these embodiments, the reduction in mass occurs not only in outer layer 126 but also with core 130 as well.

The height Ah (FIG. 19) of the plug can also be reduced in order to further reduce the mass of the plug and photometric benefits. In one exemplary embodiment, the change in height of the plug and reduction of mass should satisfy the following relationship (reduced mass plug/original mass of plug)≧((0.8*reduced height Ah of plug)/original height Ah of plug).

Returning to FIGS. 14 and 15, mold 401 can be modified to create the openings such as e.g., openings 180 and 182 shown in FIGS. 26 through 37. For example, mold surfaces 426 and/or 428 can be provided with one or more raised features to create openings 182 on the inner surface 186 of plug 112. Similarly, mold surfaces 433 and/or 434 can be provided with one or more raised features to create openings 180 in the outer surface 184 of plug 112. Other techniques may be used as well.

Another exemplary method of manufacturing a lamp of the present invention and, more particularly, an end plug such as e.g., end plug 112 or 114 is shown in FIG. 16. In step 310, a powder is compressed into an end plug intermediate 200 having an opening 202 surrounded by an outer layer 206 having an outer surface 204. The powder may be prepared from a ceramic material such as e.g., aluminum oxide.

Next, in step 320, a cermet material is placed into the opening 202 of intermediate 200. The cermet material may be prepared from e.g., a ceramic material and an electrically conductive metal. End plug intermediate 200 is compressed to provide a core 208 of the cermet within outer layer 206. Outer surface 204 is then machined to create a flange or rim 212 that can be used e.g., as stop when the resulting plug is placed in the body of lamp such as e.g., body 102. A hole 209 may be created in core 208 for receipt of an electrode.

In step 330, an electrode 210 is inserted into core 208. Electrode 210 may be placed into hole 209 or, if no hole is provided, then inserted partially into—or completely though—core 208. FIGS. 14-16 are provided by way of example only. Using the teachings disclosed herein, one of skill in the art will understand that other exemplary methods may be used to manufacture plugs for a voidless CMH lamp of the present invention. For example, electrode 210 may be dipped or coated with a slurry that includes a ceramic material or cermet before being inserted into core 208. Other variations may also be used.

Table IV provides experimental results used to develop embodiments of the invention where cracks in the cermet or alumina portions of the plug would be avoided. Hermeticity between the plug and lamp body can be obtained by well-established principles of cosintering Alumina parts. Under “Factors,” Table IV lists parameters varied by established statistical principles with the alumina weight in grams and the dimensions in millimeters (mm). Under “Response,” Table IV lists all the measured values for the plugs in millimeters (mm).

TABLE IV

| | | | | | Response | | | | | |
|---|---|---|---|---|---|---|---|---|---|---|
| | | | | | | | | | Sintered- | Sintered- |
| | Factors | | | | | Sint. Ht- | Sint. D- | # of | Cermet D | Cermet D |
| Cell | Al2O3 Wt | Initial P. | Cermet D | Final P. | Green Ht | Plug | Plug | Cracks | (mid) | (end) |
| 1 | 0.15 | 16 | 1.55 | 800 | 3.3 | 2.5 | 4.3 | 0 | 1.0 | 1.4 |
| 2 | 0.1 | 16 | 2.5 | 800 | 2.3 | 1.8 | 4.3 | 0 | 1.2 | 1.6 |
| 3 | 0.1 | 16 | 1.55 | 200 | 2.4 | 2.5 | 4.3 | 0 | 0.8 | 1.0 |
| 4 | 0.1 | 16 | 1.55 | 800 | 2.2 | 1.7 | 4.3 | 0 | 0.8 | 1.0 |
| 5 | 0.15 | 16 | 1.55 | 200 | 3.7 | 2.8 | 4.1 | 0 | 0.8 | 1.0 |
| 6 | 0.1 | 4 | 1.55 | 200 | 2.4 | 1.9 | 4.1 | 0 | 0.8 | 1.0 |
| 7 | 0.1 | 4 | 2.5 | 200 | 2.6 | 2.0 | 4.2 | 0 | 1.2 | 1.5 |
| 8 | 0.1 | 4 | 1.55 | 800 | 2.2 | 1.7 | 4.3 | 0 | 0.8 | 1.0 |
| 9 | 0.15 | 4 | 1.55 | 200 | 3.7 | 2.8 | 4.1 | 0 | 0.8 | 1.0 |
| 10 | 0.1 | 4 | 2.5 | 800 | 2.4 | 1.8 | 4.3 | 0 | 1.3 | 1.6 |
| 11 | 0.15 | 4 | 1.55 | 800 | 3.4 | 2.6 | 4.3 | 0 | 0.9 | 1.0 |
| 12 | 0.1 | 16 | 2.5 | 200 | 2.5 | 1.9 | 4.2 | 0 | 1.1 | 1.5 |
| 13 | 0.15 | 4 | 2.5 | 200 | 4.0 | 3.0 | 4.2 | 1 | 1.3 | 1.6 |
| 14 | 0.15 | 16 | 2.5 | 800 | 3.5 | 2.7 | 4.3 | 2 | 1.3 | 1.6 |
| 15 | 0.15 | 4 | 2.5 | 800 | 3.6 | 2.8 | 4.3 | 3 | 1.4 | 1.7 |
| 16 | 0.15 | 16 | 2.5 | 200 | 4.0 | 3.0 | 4.2 | 3 | 1.2 | 1.6 |

With the results of such experiments, the inventors have discovered that specific conditions should be used get certain desirable results such as crack free plugs. These conditions will now be described.

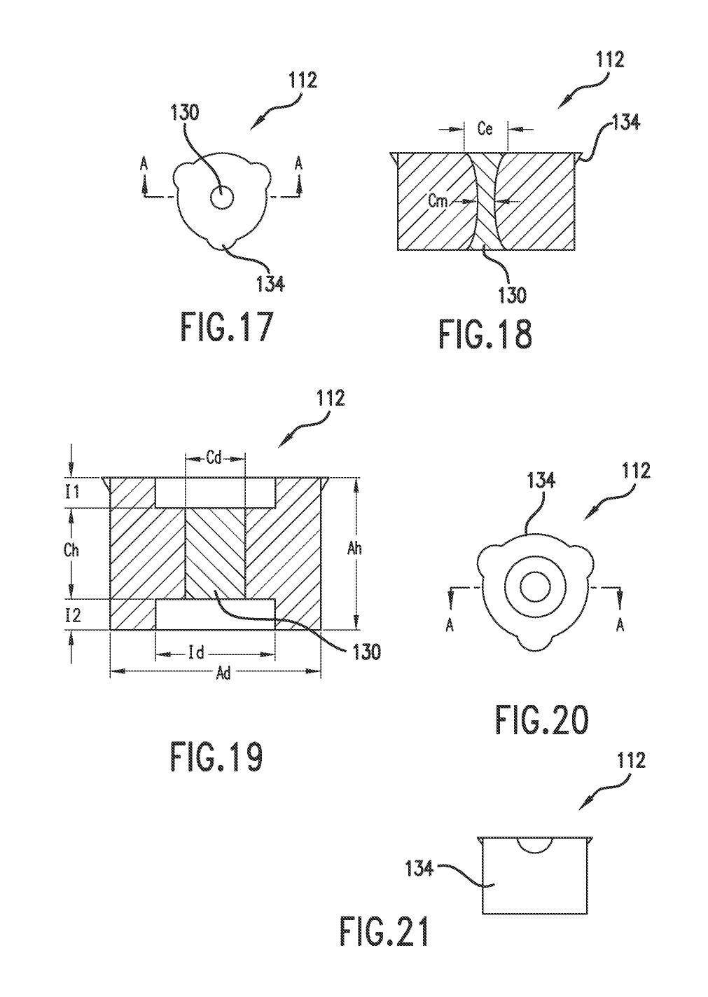

With reference to FIGS. 17 and 18, the inventors discovered that using the teaching disclosed herein the cermet core 130 of the plug 112 will form an hourglass shape. The hourglass shape can be described with two distinct diameters: a mid-cermet diameter referred to as Cm, and an end cermet diameter referred to as Ce. These two diameters are very strongly correlated to the “green” or “unsintered” cermet diameter, referred to in Table I as dimension D. The inventors have discovered that by following the following inequalities, crack free plugs can be provided:

$$\begin{matrix}\frac{Cm}{Ce} \leq 0.83 & Eqn . 9 \\ \frac{Cm}{Cermet D} \leq 0.51 & Eqn . 10\end{matrix}$$

The hourglass shape provides a lower stress design for the cermet portion 130 of plug 112. If the above inequalities are met, a plug with no cracks can be provided. By way of example, in one exemplary embodiment, Cm was 0.2 mm, Ce=0.34 mm, and Cermet D=1.55 mm.

The plugs created in Table IV allowed for density of sintered cermet and alumina sections of the plugs to be determined. The inventors have discovered that the sintered density of the outer layer of ceramic material, ρ_{SOD}, should be greater than, or equal to, the sintered density of the cermet core, ρ_{SCD}. Stated mathematically, ρ_{SOD}≧ρ_{SCD}. In still another embodiment, the inventors have determined that the following inequality can provide components that are free from cracks:

$$\frac{Sintered Cermet Density}{Sintered Alumina Density} \geq 0.5 \qquad Eqn . 11$$

or (ρ_{SCD}/ρ_{SOD}) is greater than, or equal to, about 0.5, but less than 2

Providing parts that meet this inequality provides for proper functioning of the plugs. Additionally, it should be noted that the cermet density formed by this process is significantly less than the cermet density of a plug made of only cermet. For such a cermet, i.e., pressed cermet by itself, if the percent of molybdenum in the alumina is 50%, then the density will be about 7 gm/cc. In the cermet of the plugs described as exemplary embodiments of the present invention, the densities of the cermets are typically in the 3-4 gm/cc range. This lower density, or a smaller packing fraction, creates lower stresses in the interface between the cermet and the alumina portions of the plug and is an important and novel feature for success of this design.

FIGS. 19, 20, and 21 are used to illustrate the importance of putting a small indentation in the plug as described herein in order to facilitate defect free parts. The various dimensions annotated in this figure follow the guidelines in the equations described below, where the numerical values are in millimeters (mm).

$$\begin{matrix}0.01 \leq Ad \leq 100 & Eqn . 12 \\ 0.01 \leq Cd \leq 100 & Eqn . 13 \\ Cd < Ad & Eqn . 14 \\ Ch \geq 1 / Cd & Eqn . 15 \\ 0.0001 \leq \frac{Cd}{Ad} \leq 1 & Eqn . 16 \\ 0.01 \leq \frac{Id}{Ad} \leq Cd & Eqn . 17 \\ A h \geq \frac{1}{Id} & Eqn . 18 \\ 0.1 \leq A h \leq 1000 & Eqn . 19 \\ I 1 + I 2 \geq \frac{1}{A h} & Eqn . 20\end{matrix}$$

For a plug such as plug 112 to have the desired properties, the cermet diameter, Cd, must be less than the plug diameter, Ad. Also, the first two inequalities (Eqn. 12 and 13) define the range of permissible plug and cermet diameters. The fourth inequality describes the relationship between Cd and Ad that should be used to make successful crack free plugs. The inventors have discovered that an indentation defined by Id and I1 and I2 in FIG. 19 is effective in eliminating loosely packed powder at the insertion point of feedthroughs. Failure to provide this indentation can result in a far greater incidence of cracks in the plugs. The inequalities described in the Equations 15-17 above constrain the ranges for this indentation and its relationship to parameters such as Ad and Cd of the plug. In one exemplary embodiment of the invention, Ad=4 mm, Cd=1.5 mm, Id=1.5 mm, Ah=3.8 mm, Ch=2.8 mm, I1 & I2=0.5 mm.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of manufacturing a lamp, the lamp including a body having a reduced mass end plug received into the body, the method comprising the steps of:
providing a mold constructed from a first mold portion connectable to a second mold portion so as to form a mold cavity, the second mold portion having a first aperture facing the mold cavity;
positioning a mandrel into the first aperture of the second mold portion, the mandrel extending into the mold cavity;
introducing a powder comprising a ceramic material into the mold cavity around the mandrel;
compressing the powder around the mandrel in the mold cavity to create an end plug intermediate having an opening surrounded by ceramic material;
replacing the second mold portion of the mold and the mandrel with a third mold portion defining a second aperture facing the mold cavity;
inserting an electrode through the opening in the end plug intermediate and into the second aperture defined by the third mold portion;
placing cermet material into the opening in the end plug intermediate; and
compressing the end plug intermediate to further compact the ceramic material and cermet to create the end plug having a core of the cermet material surrounded by an outer layer of ceramic material.

2. A method of manufacturing a lamp as in claim 1, wherein said step of compressing the powder comprises inserting a first shaft into the mold cavity to press the powder.

3. A method of manufacturing a lamp as in claim 2, wherein said first shaft includes a first guide channel for receipt of the mandrel, and wherein said method further comprises sliding the mandrel within the first guide channel during said step of compressing the powder.

4. A method of manufacturing a lamp as in claim 1, wherein said step of inserting an electrode comprises:
positioning a second shaft into the mold cavity of the first mold portion, wherein the second shaft has a second guide channel;
extending an electrode guide carrying the electrode into the second guide channel; and
contacting the second shaft against the end plug intermediate; and
applying a force to the electrode to position the electrode into the end plug intermediate.

5. A method of manufacturing a lamp as in claim 1, wherein the end plug has an outer surface and an inner surface, the method further comprising the step of forming one or more openings in the outer surface of the end plug.

6. A method of manufacturing a lamp as in claim 5, further comprising the step of providing the second mold portion, the third mold portion, or both, with one or more raised features for forming one or more openings in the outer surface of the plug.

7. A method of manufacturing a lamp as in claim 1, wherein the end plug has an outer surface and an inner surface, and wherein the method further comprises the step of forming one or more openings in the inner surface of the end plug.

8. A method of manufacturing a lamp as in claim 1, wherein said step of compressing the powder comprises:
providing a first shaft having one or more raised features on a distal end of the first shaft; and
inserting the first shaft into the mold cavity and into contact with the powder so as to create one or more openings on the inner surface of the end plug.

9. A method of manufacturing a lamp as in claim 1, wherein said powder comprises a ceramic material.

10. A method of manufacturing a lamp as in claim 9, wherein said powder comprises aluminum oxide.

11. A method of manufacturing a lamp as in claim 1, further comprising the step of co-sintering the core and the outer layer.

12. A method of manufacturing a lamp as in claim 1, further comprising the steps of
providing the body of the lamp with an opening;
positioning the end plug into the opening; and
co-sintering the core with the outer layer and the body of the lamp with the outer layer.

13. A method of manufacturing a lamp, the lamp including a body having an end plug received into the body, the method comprising the steps of:
compressing a powder comprising a ceramic material into an end plug intermediate having an opening;
placing a mixture comprising a cermet material into the opening of the end plug intermediate; and
compressing the end plug intermediate to create the end plug having a core comprising cermet material surrounded by the ceramic material.

14. A method of manufacturing a lamp as in claim 13, the method further comprising the step of inserting an electrode into the core of the end plug.

15. A method of manufacturing a lamp as in claim 14, the method further comprising the step of removing ceramic material from an outer edge of the end plug intermediate or the end plug so as create a flange on the end plug.

16. A method of manufacturing a lamp as in claim 15, wherein the electrode is inserted only partially through the core.

17. A method of manufacturing a lamp as in claim 13, wherein the end plug has an outer surface and an inner surface, and further comprising the step of providing the outer surface with one or more openings.

18. A method of manufacturing a lamp as in claim 13, wherein the end plug has an outer surface and an inner surface, and further comprising the step of providing the inner surface with one or more openings.

19. A method of manufacturing a lamp as in claim 13, wherein the ceramic material comprises aluminum oxide.

20. A method of manufacturing a lamp as in claim 13, wherein the cermet material comprises a ceramic material and an electrically conductive metal.
